(19) United States
(12) Patent Application Publication
(10) Pub. No.: US 2026/0338140 A1
(43) Pub. Date: Oct. 29, 2026

(54) GAS INJECTOR WITH A DAMPER

(71) Applicant: Robert Bosch GmbH, Stuttgart (DE)

(72) Inventors: Dietmar Schmieder, Markgroeningen (DE); Hubert Stier, Vaihingen/Enz (DE)

(21) Appl. No.: 19/111,707

(22) PCT Filed: Jun. 28, 2023
(86) PCT No.: PCT/EP2023/067627

§ 371 Date: May 2, 2025

(30) Foreign Application Priority Data
Sep. 14, 2022 (DE) 10 2022 209 611.8

(51) Int. Cl. F02M 21/02; F01M 9/04

(52) U.S. Cl. CPC F02M 21/0254; F01M 9/04; F02M 21/0257

(57) ABSTRACT

The present invention relates to a gas injector for injecting a gaseous fuel, comprising: a magnetic actuator (2) with an armature (20); a closing element (3), which has a valve needle (30) and is connected to the armature (20), wherein the closing element (3) opens and closes a gas path (11) at a sealing seat (8); a closed lubricant chamber (4), in which the armature (20) is arranged; and a flexible sealing element (40), which seals the lubricant chamber (4) and makes an axial movability of the valve needle (30) possible; wherein the lubricant chamber (4) is filled with a liquid lubricant (5) and a gas (6).

### FIELD

The present invention relates to a gas injector for injecting a gaseous fuel, in particular hydrogen or natural gas or the like, the gas injector having improved damping properties and a short and compact axial design. The gas injector is designed in particular for direct injection into a combustion chamber of an internal combustion engine.

### BACKGROUND INFORMATION

Many gas injectors are described in the related art in different designs. One principle-related problem with gas injectors is that, due to the gaseous medium to be injected, lubrication by the medium is not possible, as is the case, for example, with fuel injectors that inject gasoline or diesel. This results in excessive wear during operation of the gas injector. Furthermore, due to the increasing miniaturization of internal combustion engines, it is necessary that gas injectors also take up little space if possible.

### SUMMARY

A gas injector according to the present invention for injecting a gaseous fuel, which gas injector has certain features of the present invention, has the advantage that improved function in conjunction with lubrication of moving parts of the gas injector is possible. The gas injector according to the present invention also has a very compact and short structure, in particular in the axial direction of the gas injector. This is achieved according to an example embodiment of the present invention in that the gas injector comprises a magnetic actuator with an armature which is movable in the axial direction of the gas injector. The armature is connected to a closing element of the gas injector, which closing element has a valve needle in order to open and close a gas path for the gaseous fuel at a valve seat. Furthermore, a closed lubricant chamber is provided, which is filled with a liquid lubricant, wherein the axially movable armature is arranged in the lubricant chamber. The lubricant thus ensures lubrication of the armature during operation so that no wear occurs on the armature. The lubricant chamber comprises at least one flexible sealing element, in particular a bellows, which seals the lubricant chamber against the gas path. The flexible sealing element thus ensures axial movability of the closing element and forms a housing part of the lubricant chamber. Furthermore, the lubricant chamber is filled with a gas in addition to the liquid lubricant. A defined gas volume thus exists in the lubricant chamber and makes it possible for a volume compensation unit integrated in the lubricant chamber to be present in the event of a temperature increase, which can result in an expansion of the volume of the liquid lubricant. As a result, the flexible sealing element has to ensure only the movability of the closing element in the axial direction and does not additionally have to provide a temperature-related compensation option to compensate for temperature-related volume changes of the liquid lubricant in the lubricant chamber. This results in a compact, flexible sealing element and, for example when using a bellows, in a significantly reduced axial length of the bellows.

Preferred developments and example embodiment of the present invention are disclosed herein.

The flexible sealing element is preferably a bellows, in particular a metal bellows. Due to the gas volume present in the lubricant chamber, an axial length of the bellows can be chosen to be very small so that the bellows has to ensure only the axial movability of the closing element of the gas injector. Alternatively, the flexible sealing element is a metal membrane, which can also have a simplified design due to the gas volume in the lubricant chamber.

According to an example embodiment of the present invention, preferably, the gas injector further comprises a return element, which is arranged within the lubricant chamber. The return element returns the closing element to a closed initial position. Reduced wear on the closing element can thus also be achieved during operation by arranging the closing element within the lubricant chamber.

Further preferably, according to an example embodiment of the present invention, the lubricant chamber comprises a deep-drawn part, which is designed as a housing part of the lubricant chamber. The deep-drawn part is preferably canister-shaped and further preferably has a central filling opening closed with a closure unit. The filling opening is preferably located in a central axis of the gas injector. The deep-drawn part is further preferably arranged at an end of the lubricant chamber that faces away from the combustion chamber.

The gas used in the lubricant chamber is preferably air or CO₂ or a noble gas. The lubricant is preferably an oil or a liquid fuel or perfluoropolyether (PFPE) or a heptane isomer or a nonane.

At a temperature of 20 °C, a pressure in the lubricant chamber is preferably in a range of 1 to 4×10⁵ Pa and is in particular 3×10⁵ Pa. The pressure in the lubricant chamber at 20 °C is further preferably always greater than an ambient pressure.

At a temperature of 20 °C, a volume of the liquid lubricant is larger than a volume of the gas in the lubricant chamber. The volume of the liquid lubricant at 20 °C is further preferably at least twice as large as the volume of the gas in the lubricant chamber.

Further preferably, according to an example embodiment of the present invention, a damping unit is arranged in the lubricant chamber. The damping unit preferably dampens a closing movement of the closing element in order to avoid so-called bounces, which can occur during rapid closing processes of the gas injector when the closing element hits a stop and bounces off briefly, which can result in undesired openings of the sealing seat.

Further preferably, according to an example embodiment of the present invention, the closing element is an outward-opening closing element.

Preferably, according to an example embodiment of the present invention, the flexible sealing element is connected directly to the closing element, preferably by means of a welded connection.

### BRIEF DESCRIPTION OF THE DRAWINGS

In the following, preferred exemplary embodiments of the present invention are described in detail with reference to the figures.

FIG. 1 is a schematic sectional view of a gas injector according to a first exemplary embodiment of the present invention.

FIG. 2 is a schematic partial sectional view of a gas injector according to a second exemplary embodiment of the present invention.

### DETAILED DESCRIPTION OF EXAMPLE EMBODIMENTS

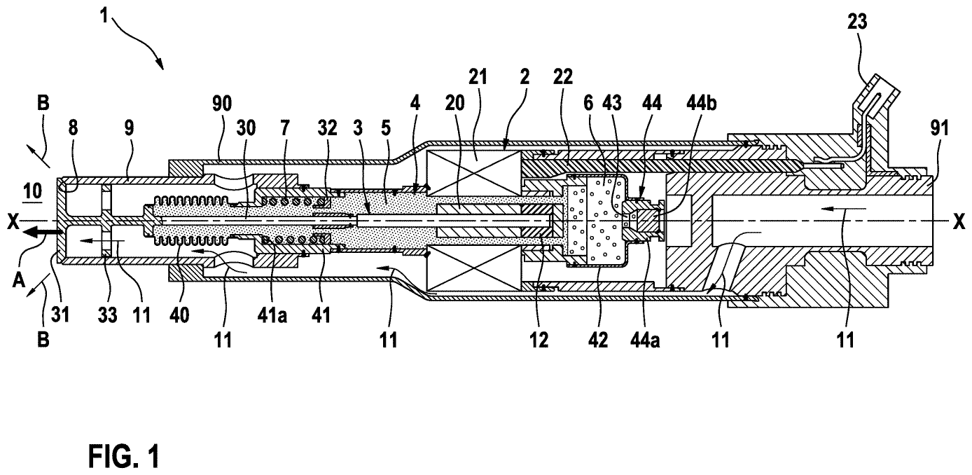

A gas injector 1 according to a first preferred exemplary embodiment of the present invention is described in detail below with reference to FIG. 1.

As can be seen in FIG. 1, the gas injector 1 for injecting a gaseous fuel into a combustion chamber 10 comprises a magnetic actuator 2, which moves an outward-opening closing element 3 from a closed state to an open state. FIG. 1 shows the closed state of the gas injector.

The magnetic actuator 2 comprises an armature 20 and a coil 21, wherein the armature 20 is connected to the closing element 3. The closing element 3 comprises a valve needle 30 and a valve plate 31, which opens and closes a passage for injecting the gaseous fuel at a sealing seat 8. The sealing seat 8 is formed between the valve plate 31 and a valve body 9.

The gas injector 1 further comprises a gas connection 91, through which the gaseous fuel is fed into the gas injector.

Reference sign 11 denotes a gas path, which runs through the gas injector 1. The valve body 9 is connected to a housing sleeve 90, for example by means of a welded connection. The gas path 11 runs from the gas connection 91, which is located centrally in a central axis X-X of the gas injector, radially outward and flows around the magnetic actuator 2.

The gas injector 1 further comprises a closed lubricant chamber 4, which accommodates multiple components of the gas injector 1. The lubricant chamber 4 is filled with a liquid lubricant 5 and a gas 6.

Furthermore, the gas injector 1 comprises a return element 7, which returns the closing element 3 to the closed position shown in FIG. 1. The return element 7 is likewise arranged inside the lubricant chamber 4.

The lubricant chamber 4 comprises a flexible sealing element 40, which is a metal bellows in this exemplary embodiment. Furthermore, the lubricant chamber 4 comprises a sleeve 41, which is fixedly connected to the coil 21. A shoulder 41a, on which a first end of the return element 7 is supported, is provided inside the sleeve 41. A second end of the return element 7 is supported on a spring plate 32, which is firmly connected to the valve needle 30.

As can also be seen in FIG. 1, the closing element 3 has a guide element 33, which is formed on the valve needle 30 in the region of the valve body 9. The guide element 33 guides the closing element 3 on an inner circumference of the valve body 9 and has multiple apertures for the gas path 11.

At an end of the lubricant chamber 4 that faces away from the combustion chamber, a deep-drawn part 42 is arranged, which closes the lubricant chamber 4. The deep-drawn part 42 is made of a thin metal material and is substantially canister-shaped. The deep-drawn part 42 has a filling opening 43, which is closed by means of a closure unit 44. The closure unit 44 comprises, for example, a sealing ring 44a and a cylindrical pin 44b.

Also arranged in the lubricant chamber 4 is a damping unit 12, which makes it possible to dampen the closing element 3 before it hits a stop when the closing element 3 is returned. The damper unit 12 is, for example, an elastic material at an end of the valve needle 30 that faces away from the combustion chamber.

As can be seen in FIG. 1, a volume of the liquid lubricant 5 is significantly larger than a volume of the gas 6 in the lubricant chamber 4. The gas volume in the lubricant chamber 4 makes it possible to compress the gas volume when the volume of the liquid lubricant 5 expands in the event of a temperature increase. It was found that, during operation, the liquid lubricant 5 can expand by up to 20% due to temperature increases. In this exemplary embodiment, at 20 °C, the volume of the liquid lubricant 5 is twice as large as the volume of the gas 6.

This makes it possible for the flexible sealing element 40 to be designed such that it is only responsible for the axial movability of the closing element 3 for opening and closing. In other words, the flexible sealing element 40 does not have to compensate for any temperature-related changes in length due to expansion of the liquid lubricant. This allows an axial length of the gas injector to be significantly reduced.

The function of the gas injector according to the present invention is as follows. When current is supplied to the magnetic actuator 2, the armature is moved in the direction of the combustion chamber 10, whereby the closing element 3 opens, as indicated by arrow A in FIG. 1. As a result, the valve 31 is lifted from the sealing seat 8 and the gaseous fuel is injected via the opened passage at the sealing seat 8. This is indicated by arrows B in FIG. 1.

For terminating the injection, the current supply to the magnetic actuator 2 is terminated so that the closing element 3 is returned by means of the return element 7 to the closed position shown in FIG. 1. The damping unit 12 at the end of the closing element 3 that faces away from the combustion chamber prevents so-called bounces when the closing element 3 reaches its end position at a stop.

The axial movement of the closing element 3 is realized only by means of the flexible sealing element 40. Increasing temperatures during operation, which can result in an expansion of the volume of the liquid lubricant 5, are compensated for by compression of the gas 6 in the lubricant chamber 4. This may result in an increase in pressure in the lubricant chamber 4, which increase in pressure, however, has no negative effects on the function of the gas injector during opening and/or closing. Oil is preferably used as the liquid lubricant, and air is preferably used as the gas 6.

Since the installation position of the gas injector 1 in an internal combustion engine is usually such that the sealing seat 8 is directed downward, the gas 6 is substantially located in the deep-drawn part 42, as indicated in FIG. 1. In principle, however, an installation position of the gas injector 1 in an internal combustion engine has no effect on the above-described function of the lubricant chamber 4 filled with a liquid lubricant 5 and a gas 6.

Thus, a plurality of moving parts of the gas injector are arranged inside the lubricant chamber 4, so that a significant reduction of wear on these moving components is possible. This can significantly prolong a service life of the gas injector.

The flexible sealing element 40 is connected to the valve needle 30 by means of a welded connection, for example. Preferably, a welded connection is also provided between the flexible sealing element 40 and the sleeve 41 of the housing of the lubricant chamber 4. In this way, the lubricant chamber can be prefabricated and then filled via the filling opening 43, wherein filling of the gas 6 is also possible under pressure. After filling, the lubricant chamber 4 is then closed by the closure unit 44, for example a cylindrical pin.

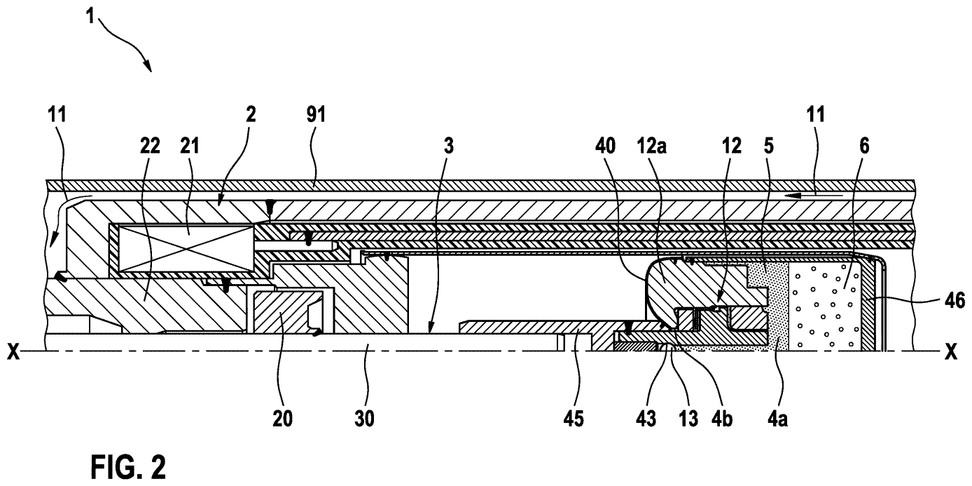

FIG. 2 shows a gas injector 1 according to a second exemplary embodiment of the present invention. Identical or functionally identical parts are denoted by the same reference signs as in the first exemplary embodiment.

In contrast to the first exemplary embodiment, the gas injector 1 of the second exemplary embodiment has a metal membrane as a flexible sealing element 40. The membrane is connected to the valve needle 30 via a sleeve 45 and is connected with a radially outer circumference to a base body 12a of the damping unit 12. The damping unit 12 makes a fluid connection from a first chamber 4a of the lubricant chamber 4 to a second chamber 4b possible. The damper unit 12 makes damping possible both during an opening process of the closing element 3 and during a closing process of the closing element 3. As is clear from FIG. 2, the use of the metal membrane as a flexible sealing element 40 makes further reduction of the axial length of the gas injector 1 possible. As a result, a particularly compact structure can be realized. The use of a bellows is no longer necessary. The lubricant chamber 4 is formed at an end that faces away from the combustion chamber and has a canister 46, which substantially defines a volume capacity of the lubricant chamber 4. The size of the volume of the lubricant chamber 4 is selected depending on the application. Filling of the lubricant chamber 4 can be realized, similarly to the first exemplary embodiment, by means of a filling opening in the canister 46 or, as shown in FIG. 2, through a filling opening 43 on the damper unit 12, which filling opening is closed by means of a closing ball 13. Otherwise, this exemplary embodiment corresponds to the above-described exemplary embodiment, so that reference can be made to the description given there.

1-10. (canceled)

11. A gas injector for injecting a gaseous fuel, comprising:
a magnetic actuator having an armature;
a closing element which has a valve needle and is connected to the armature, wherein the closing element opens and closes a gas path at a sealing seat;
a closed lubricant chamber in which the armature is arranged; and
a flexible sealing element which seals the lubricant chamber and makes axial movability of the valve needle possible;
wherein the lubricant chamber is filled with a liquid lubricant and a gas.

12. The gas injector according to claim 11, wherein the flexible sealing element is a bellows or a membrane.

13. The gas injector according to claim 11, further comprising a return element, wherein the return element is arranged inside the lubricant chamber.

14. The gas injector according to claim 11, further comprising a deep-drawn part, which is a housing part of the lubricant chamber.

15. The gas injector according to claim 14, wherein the deep-drawn part is canister-shaped and has a central filling opening closed by a closure unit.

16. The gas injector according to claim 11, wherein: (i) the gas in the lubricant chamber is air or carbon dioxide or a noble gas, and/or (ii) the liquid lubricant is oil or perfluoropolyether or a heptane isomer or a nonane.

17. The gas injector according to claim 11, wherein a pressure in the lubricant chamber is greater than an ambient pressure.

18. The gas injector according to claim 17, wherein the pressure in the lubricant chamber is in a range of 1 to 4×10⁵ Pa at 20 °C.

19. The gas injector according to claim 11, wherein a volume of the liquid lubricant is greater than a volume of the gas in the lubricant chamber.

20. The gas injector according to claim 11, further comprising:
a damper unit arranged in the lubricant chamber.
